(19) United States
(12) Patent Application Publication
(10) Pub. No.: US 2008/0230361 A1
(43) Pub. Date: Sep. 25, 2008

(54) Reinforced Foil-Type Switching Element

(75) Inventor: Driss Chabach, Noertrange (LU)

Correspondence Address: CANTOR COLBURN, LLP, 20 Church Street, 22nd Floor, Hartford, CT, 06103, US

(73) Assignee: IEE INTERNATIONAL ELECTRONICS & ENGINEERING S.A., Echternach (LU)

(21) Appl. No.: 11/720,466

(22) PCT Filed: Nov. 15, 2005
(86) PCT No.: PCT/EP05/55983

§ 371 Date: May 30, 2007

(30) Foreign Application Priority Data
Dec. 1, 2004 (EP) 04106230.8

(51) Int. Cl. H01H 1/10

(52) U.S. Cl. 200/512

(57) ABSTRACT

A foil-type switching element comprises a first carrier foil and a second carrier foil arranged at a certain distance from each other by means of a spacer, said spacer comprising at least one recess defining an active area of the switching element. At least two electrodes are arranged in the active area of the switching element between said first and second carrier foils in such a way that, in re-sponse to a pressure acting on the active area of the switching element, the first and second carrier foils are pressed together against the reaction force of the elastic carrier foils and an electrical contact is established between the at least two electrodes. According to the invention said spacer comprises at least one first reinforcement layer.

### INTRODUCTION

The present invention generally relates to a foil-type switching element comprising a first carrier foil and a second carrier foil arranged at a certain distance from each other by means of a spacer. The spacer comprises at least one recess, which defines an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes.

Several embodiments of such foil-type switching elements are well known in the art. Some of these switching elements are configured as simple switches comprising e.g. a first electrode arranged on the first carrier foil and a second electrode arranged on the second carrier foil in a facing relationship with the first planar electrode. The electrodes may be of a planar configuration covering essentially the entire surface of the respective carrier foil inside of the active area.

Other switching elements known in the art are configured as pressure sensors having an electrical resistance, which varies with the amount of pressure applied. In a first embodiment of such pressure sensors, a first electrode is arranged on the first carrier foil and a second electrode is arranged on the second carrier foil in facing relationship with the first electrode. At least one of the electrodes is covered by a layer of pressure sensitive material, e.g. a semiconducting material, such that when the first and second carrier foils are pressed together in response of a force acting on the switching element, an electrical contact is established between the first and second electrode via the layer of pressure sensitive material. The pressure sensors of this type are frequently called to operate in a so called “through mode”.

In an alternative embodiment of the pressure sensors, a first and a second electrode are arranged in spaced relationship on one of the first and second carrier foils while the other carrier foil is covered with a layer of pressure sensitive material. The layer of pressure sensitive material is arranged in facing relationship to the first and second electrode such that, when said first and second carrier foils are pressed together in response to a force acting on the active area of the switching element, the layer of pressure sensitive material shunts the first and second electrode. These sensors are called to operate in the so-called “shunt mode”.

The above-described switching elements can be manufactured cost-effectively and have proven to be extremely robust and reliable in practice. That's why such switching elements are commonly used in automotive safety applications e.g. as seat occupation sensors for controlling secondary restraint systems.

The electrical response of such a switching element depends on the type of the electrodes, the presence of a possible layer of pressure sensitive material, the design of the electrodes and their arrangement within the active area of the switching element and finally on the physical contact, which is established between the electrodes in response to a force acting on the active area. The physical contact between the electrodes is determined by the mechanical response of the switching element in case of a force acting on the active area. This mechanical response depends on the elastic properties of the carrier foils (mainly the modulus of elasticity), the lateral dimension of the active area and the distance between the two opposed carrier foils.

In order to ensure a reliable sensor response in a wide temperature range (e.g. between −40° C. and +105° C.), the material of the carrier foils has to be suitably chosen so as to exhibit a high and constant elasticity modulus over the temperature range. Furthermore the material should provide a good mechanical robustness and a high chemical resistance to the switching element. A high resistance against humidity is preferable. Besides these requirements, the material should provide a good adhesion to the conductive ink of the electrodes and resist to the ink stresses during the curing of the ink in order to minimise deformation of the carrier foil. The material should also allow an adequate coating with semi-conducting materials and should not be susceptible to electrical discharging. Finally the costs for the material to be used should be low.

Unfortunately no substrate material in the market fulfils all these requirements so that the choice of the material finally constitutes a compromise between the desired properties and costs for the material. While new materials with high and rather constant modulus of elasticity in the interesting temperature range may be found, these materials often suffer from unsuitable mechanical strength so that the switching elements may suffer from insufficient tearing resistance or tensile strength etc.

### OBJECT OF THE INVENTION

The object of the present invention is to provide a switching element with enhanced mechanical properties.

### GENERAL DESCRIPTION OF THE INVENTION

This object is achieved by a foil-type switching element according to claim 1. This foil-type switching element comprises a first carrier foil and a second carrier foil arranged at a certain distance from each other by means of a spacer, said spacer comprising at least one recess defining an active area of the switching element. At least two electrodes are arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes. According to the invention said spacer comprises at least one first reinforcement layer.

The present invention thus proposes a foil-type switching element with reinforced spacer layer, which provides the switching element with enhanced mechanical properties such as e.g. tensile strength or tear resistance. The spacer layer usually surrounds the active areas of the switching element, so that the enhanced mechanical properties are conferred in all directions.

It will be noted that the reinforcement of the spacer layer does not affect the mechanical properties of the carrier foils and accordingly does not alter the mechanical response of the active area to an outer force acting on the sensor. Thus the mechanical strength properties of the switching element may be adjusted to the specific needs of an application independently from those properties affecting the mechanical response of the sensor cell.

The first reinforcement layer may comprise any suitable material having a high tensile strength and tear resistance. The first reinforcement layer may e.g. comprise a sheet of a suitable polymer. In a preferred embodiment of the invention, said first reinforcement layer comprises however a textile material e.g. made of aramid, polyamide, polyester, or the like.

In a possible embodiment of the switching element, said spacer comprises an adhesive material and said first reinforcement layer is embedded into said adhesive material. The spacer may e.g. comprise a printable adhesive in which the reinforcement layer may be embedded. In another embodiment the spacer layer is formed of a double-sided adhesive film, i.e. said spacer comprises a carrier material and an adhesive arranged on said carrier material. In this embodiment, said first reinforcement layer may be laminated onto said carrier material.

It will be noted that in addition to a reinforced spacer layer, said first carrier foil and/or said second carrier foil may comprise a multilayered configuration with at least one carrier layer and at least one second reinforcement layer, made e.g. from a textile material. Said second reinforcement layer is e.g. laminated onto said carrier layer. Such multi-layered configuration of the carrier foils may be used for further enhancing mechanical properties as tensile strength or resistance to tear propagation without affecting the modulus of elasticity of the carrier foil.

The skilled person will appreciate, that the present invention is applicable to simple membrane switches as well as to pressure sensitive switches. In case of a simple membrane switch a first electrode is arranged on an inner surface of said first carrier foil and a second electrode is arranged on an inner surface of the second carrier foil in a facing relationship with said first electrode. In a variant of a simple switch, a first and a second electrode are arranged side by side on an inner surface of said first carrier foil and a shunt element is arranged on an inner surface of the second carrier foil in facing relationship with said first and second electrodes. The two electrodes may e.g. comprise a comb shaped configuration, with the teeth of the two electrodes being arranged in an interdigitating relationship. Foil-type pressure sensors are similarly configured as the above-described switches. In contrast to the switches, at least one of said first and second electrode is covered by a pressure-sensitive resistive material. In an alternative embodiment, the said shunt element comprises a resistive material. Due to the pressure-sensitive resistive or semi-conducting material, the electrical resistance between the electrodes of these pressure sensors depends on the pressure with which the two carrier foils are pressed together.

### DETAILED DESCRIPTION WITH RESPECT TO THE FIGURES

The present invention will be more apparent from the following description of several not limiting embodiments with reference to the attached drawings, wherein

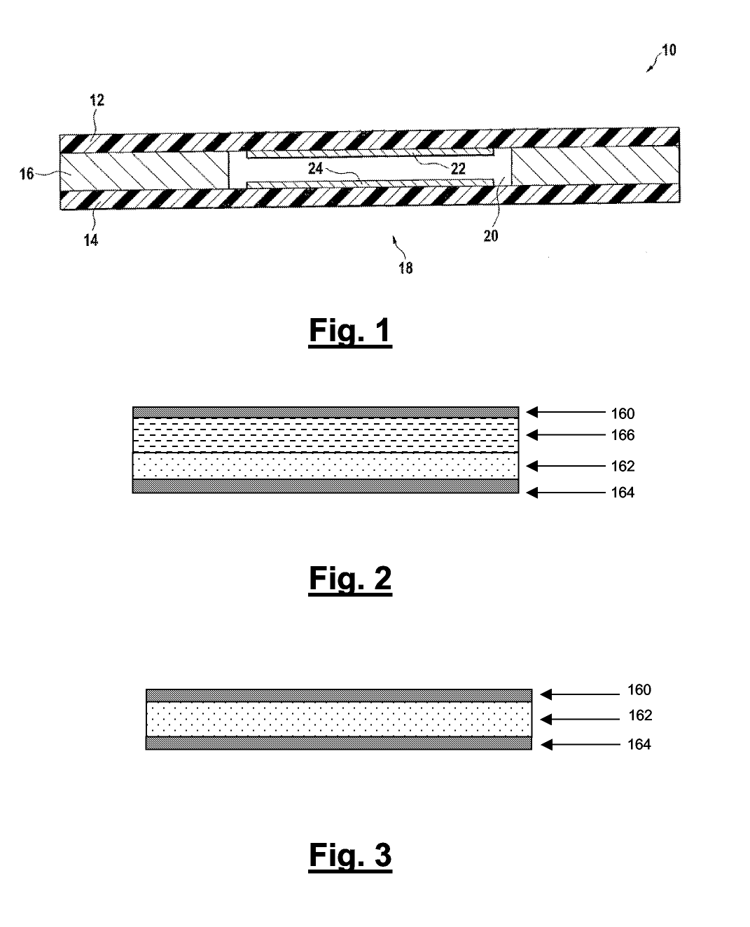

FIG. 1: generally shows a section of a foil-type pressure sensor;

FIG. 2: shows a first embodiment of a reinforced spacer layer;

FIG. 3: shows a second embodiment of a reinforced spacer layer.

A section of a typical foil-type pressure sensor 10 is represented in FIG. 1. The pressure sensor 10 comprises a first carrier foil 12 and a second carrier foil 14, which are arranged at a certain distance by means of a spacer 16. The spacer 16 may e.g. comprise a double-sided bonding sheet. In an active area, generally referenced as 18, of the pressure sensor 10, the spacer 16 comprises a recess or cut-out 20 such that, in the active area 18, the two carrier foils 12 and 14 face each other at a certain distance.

Contact arrangements 22 and 24 are arranged in the active area 18 on the inner surfaces of the carrier foils 12 and 14 in such a way that an electrical contact is established between the contact arrangements 22 and 24 if said carrier foils are pressed together. In the shown embodiment, one contact arrangement 22 or 24 is arranged on each of said carrier foils 12 and 14 in a facing relationship. It should however be noted that other layouts, e.g. with two spaced contact arrangements 22 and 24 arranged on one of the carrier foils and a shunt element arranged on the second carrier foil, are also possible.

The contact arrangements may comprise electrodes, wherein at least one of the contact arrangements comprises a layer of pressure sensitive material. Such a layer of pressure sensitive material confers a pressure depending behaviour to the pressure sensor. It should be noted that the contact arrangements are usually printed onto the respective carrier foils using a screen-printing process prior to the laminating process, in which the carrier foils and the spacer are laminated together.

To guarantee the same sensor response over the automotive temperature range (−40° C. to 105° C.), the use of a carrier foil material with a constant elasticity modulus over this temperature range is a needed. Furthermore the film should posses the following properties to fulfil e.g. the automobile and sensor manufacturing requirements: very good mechanical robustness, high chemical resistance, high resistance against humidity quick relaxation after a submission to high stress at high temperature (creep), high and constant elasticity modulus good ink adhesion or allowing an adequate coating, resist the ink stress during the ink curing (no deformation), no electrical discharging (static electricity) and low price. The carrier foil therefore may e.g. comprise a material chosen from the group consisting of polyetheretherketone, polyethersulfone, polyphenylsulfone, polysulfone, polycarbonate, copolycarbonate, polyphenylene ether, cycloolefin-polymer, polycarbonate/acrylonitrile butadiene styrene, polycarbonate/polybutylene terephthalate, polycarbonate/polyethylene terephthalate, polyphenylene ether/polyamide, or any other suitable material. It will be noted that if necessary the carrier foil may be subject to a surface treatment in order to enhance the adhesion on the printed electrodes.

In order to provide a pressure sensor with enhanced mechanical properties as tensile strength or resistance to tear propagation, the spacer layer 16 is provided with at least one layer of a textile material 160. Different embodiments of such multi-layered reinforced spacer layers are shown in FIGS. 2 and 3.

FIG. 2 shows an embodiment of a spacer layer, which is formed by a double-sided adhesive film. Such double-sided adhesive film usually comprises a carrier material 166, e.g. a thin polymer film, and two layers of adhesive 160 and 164, one arranged on each face of the polymer film. In the shown embodiment of FIG. 2, the reinforced spacer layer comprises a textile layer 162, which is laminated onto the carrier film 166, thus forming a multi-layered carrier material providing enhanced mechanical properties.

FIG. 3 shows an embodiment of a reinforced spacer layer, in which a textile reinforcement layer 162 is embedded in an adhesive material. In this embodiment, the textile reinforcement layer 162 acts somehow as carrier material for two adhesive layers 160 and 164.

The skilled person will appreciate, that in order to provide a pressure sensor with further enhanced mechanical properties as tensile strength or resistance to tear propagation, one or both of the carrier foils 12 and 14 may also be provided with a multi-layered configuration comprising at least one layer of a textile material. It will be noted that the use of a textile layer may enable to enhance the above-mentioned mechanical properties without affecting the modulus of elasticity of the carrier foil in a direction perpendicular to the carrier foil plane.

### LIST OF REFERENCE SIGNS

### List of Reference Signs

10 switching element
12 first carrier foil
14 second carrier foil
16 spacer
18 active area
20 recess or cut-out
22, 24 contact arrangements
160, 164 adhesive layers
162 textile layer
166 polymer carrier film

1. Foil-type switching element comprising
a first carrier foil and a second carrier foil arranged at a certain distance from each other by means of a spacer, said spacer comprising at least one recess defining an active area of the switching element, and
at least two electrodes arranged in the active area of the switching element between said first and second carrier foils in such a way that, in response to a pressure acting on the active area of the switching element, the first and second carrier foils are pressed together against the reaction force of the elastic carrier foils and an electrical contact is established between the at least two electrodes,
wherein said spacer comprises at least one first tear resistance reinforcement layer.

2. Foil-type switching element according to claim 1, wherein said first tear resistance reinforcement layer comprises a textile material.

3. Foil-type switching element according to claim 1, wherein said spacer comprises an adhesive material and wherein said first tear resistance reinforcement layer is embedded into said adhesive material.

4. Foil-type switching element according to claim 1, wherein said spacer comprises a carrier material and an adhesive arranged on said carrier material and wherein said first tear resistance reinforcement layer is laminated onto said carrier material.

5. Foil-type switching element according to claim 1, wherein said first carrier foil and/or said second carrier foil comprises a multilayered configuration with at least one carrier layer and at least one second tear resistance reinforcement layer.
